(19) United States
(12) Patent Application Publication
(10) Pub. No.: US 2010/0112540 A1
(43) Pub. Date: May 6, 2010

(54) SYSTEM AND METHOD OF EDUCATION UTILIZING MOBILE DEVICES

(75) Inventors: Shawn Gross, Arlington, VA (US); Srinivas Kallakurchi, Pepperell, MA (US)

Correspondence Address: DICKSTEIN SHAPIRO LLP, 1825 EYE STREET NW, Washington, DC, 20006-5403, US

(73) Assignee: Digital Millennial Consulting LLC, Arlington, VA (US)

(21) Appl. No.: 12/533,794

(22) Filed: Jul. 31, 2009

Related U.S. Application Data
(60) Provisional application No. 61/193,180, filed on Nov. 3, 2008.

(51) Int. Cl. G09B 7/00

(52) U.S. Cl. 434/351; 434/362

(57) ABSTRACT

A wireless communication system is disclosed, using a server, a teacher computer, an administration computer, and wireless mobile device for delivering educational content to students.

### CLAIM OF PRIORITY

This patent application claims priority to U.S. Provisional Application No. 61/193,180 filed on Nov. 3, 2008 in the U.S. Patent and Trademark Office, the entire disclosure of which is incorporated by reference herein.

### FIELD OF THE INVENTION

Described embodiments relate generally to the field of internet-enabled education systems, and more particularly, to a wireless system for education communications wherein problem sets are presented to students via a mobile wireless device.

### BACKGROUND OF THE INVENTION

The traditional method of education in the United States employs classroom teaching. In the classroom environment, a teacher or instructor conducts a live lecture covering a particular topic. This is often followed by an assignment or assignments to be completed by students in order to aid in learning, practicing, and reinforcing the content supplied in the lecture. Advancement in technology, particularly with respect to the development of the personal computer and the Internet, has provided significant enhancements to this educational model.

Personal computers have provided new ways to present information, enabling greater use of visuals and multimedia content. Technologies such as powerpoint and interactive whiteboards allow teachers to conduct lectures more efficiently. More recently, virtual classrooms have developed to allow students and teachers to interact via the Internet. These virtual classroom systems provide a collection of tools for assessment, communication, uploading content, returning student's work, collecting and organizing student grades, and administration. Teachers can post lectures, assignments, or notes, and students can log into a web page or internet-enabled application to view the lectures, or receive and submit assignments. Existing virtual classroom environments enable various levels of interaction between students and teachers via message boards or chat rooms. These virtual classrooms can be used in place of traditional classroom teaching, or as a supplement.

A problem with existing virtual classroom environments is that they require an internet connection in the student's home, as well as the installation of other equipment, such as a desktop or laptop computer. These requirements are particularly burdensome on students in low-income areas. Many students cannot afford these expenses, or do not have access to the internet, and thus they cannot take advantage of the virtual classroom. Moreover, access through a personal computer limits mobility, and static internet access points mean that students may lose work as they move from one location to another. As a consequence, there exists a need in the art for a system of education that provides the advantages of an Internet-enabled virtual classroom without the drawbacks of these existing systems.

### BRIEF SUMMARY OF THE INVENTION

The described embodiments overcome the above deficiencies by providing a secure wireless system for education communications wherein students can access educational content and communicate with a teacher or other students via a mobile wireless device. A described embodiment includes a teacher computer for assigning problem sets, monitoring student progress, and issuing rewards, a wireless mobile device used by students for receiving problem sets, instructional content, and rewards, and for accessing social-networking functionality, an administration computer for assigning user rights and monitoring students' use, and a server for storing information and facilitating communication. Described embodiments also include a parent computer for monitoring student progress and receiving teacher feedback.

A system for presenting problem sets on a mobile wireless device is described. In an embodiment, the wireless device presents students with problems aligned to a teacher's lesson plans and correlated with state standards or other applicable standards. If the student is unable to solve the problem, the student is able to gain access to a database of supplemental content in the form of digital snippets. Digital snippets are accessible by an e-content repository, which consists of both pre-existing content, and newly created customized content. If a student requires further support, the student is given the option to gain access to support from their peers. The peer-to-peer collaboration component is a closed secure environment only accessible by users who have been given access rights and privileges. Students are then given an opportunity to solve the problem. If a correct answer is successfully submitted, the results are reported to the teacher and parents or guardians. Finally, in order to ensure mastery of the skill set and reduce the possibility of cheating, students are presented with another randomly assigned problem that is based upon the same fundamentals.

### BRIEF DESCRIPTION OF THE DRAWINGS

FIG. 1 is a schematic diagram showing the interaction and structure of components in the wireless communication system constructed in accordance with an embodiment described herein;

FIG. 2 is an illustration of a teacher homepage accessible via a teacher computer;

FIG. 3 is an illustration of the instructional center homepage accessible from the teacher homepage on the teacher computer;

FIG. 4 is an illustration of the unit information screen accessible from the instructional center homepage on the teacher computer;

FIG. 5 is an illustration of the problem set information screen accessible from the instructional center homepage on the teacher computer;

FIG. 6 is an illustration of the monitoring and reporting homepage accessible from the teacher homepage on the teacher computer;

FIG. 7 is an illustration of a student report screen accessible from the monitoring and reporting homepage on the teacher computer;

FIG. 8 is an illustration of a problem set report screen accessible from the monitoring and reporting homepage on the teacher computer;

FIG. 9 is an illustration of a wireless mobile device constructed in accordance with an embodiment described herein;

FIG. 10 is an illustration of a communities screen accessible from the wireless mobile device;

FIGS. 11a and 11b are illustrations of a communities screen showing available e-content and blogs accessible from the wireless mobile device;

FIGS. 12a and 12b are illustrations of a search screen that enables searching of available e-content and blogs;

FIGS. 13a through 13d are illustrations of the awards component of the wireless mobile device;

FIG. 14a through 14f are an illustration of the collaboration component of the wireless mobile device.

FIG. 15 is a flow chart displaying the problem solving methodology on a wireless mobile device constructed in accordance with an embodiment described herein;

FIG. 16 is a flow chart demonstrating the help options available to a user operating the wireless mobile device.

FIG. 17 is a flow chart demonstrating the authentication procedure for a wireless mobile device constructed in accordance with an embodiment described herein;

### DETAILED DESCRIPTION OF THE INVENTION

Embodiments described herein relate to a wireless system of education communications utilizing wireless mobile technology. Embodiments include a server, an administration computer, a teacher computer, a wireless mobile device, and a parent computer. These components enable the delivery of educational content to a student, with the ability to monitor and report on student activity. Embodiments described herein include a wireless mobile device used by students for accessing educational content and communicating with teachers and other students Embodiments include a method for presenting problems on the wireless mobile device.

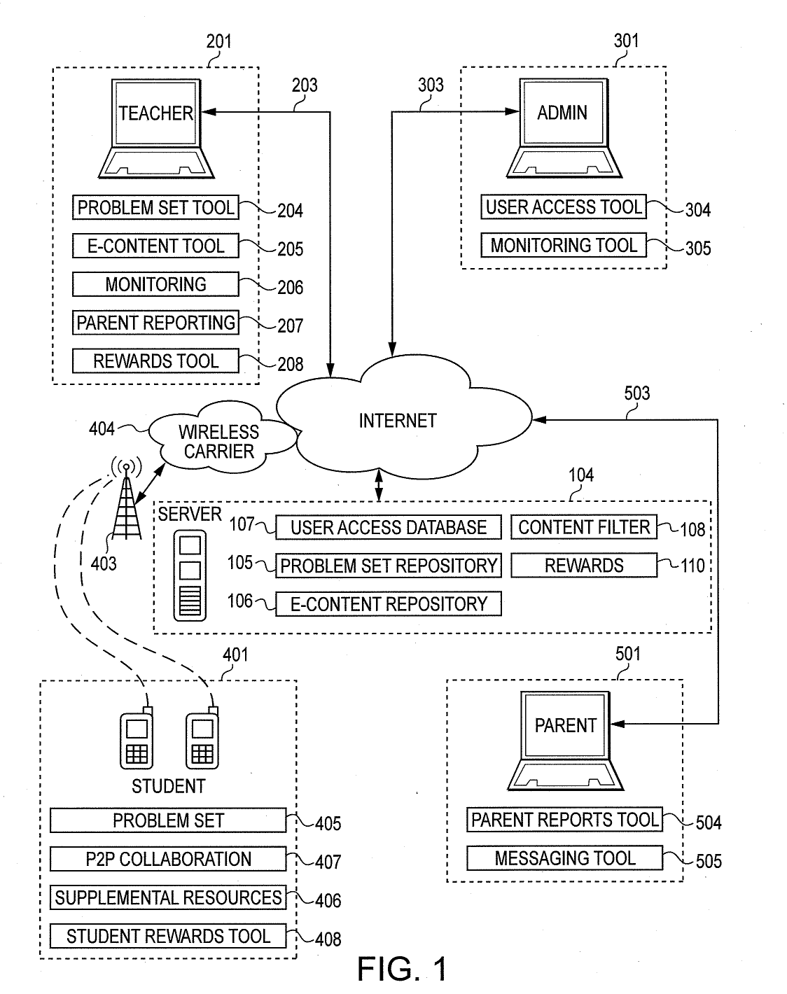

FIG. 1 is a schematic diagram showing the interaction and structure of wireless system components constructed in accordance with an embodiment described herein. A server 104 stores information and facilitates communication between the various other system components. The server 104 comprises at least one computer or computers operating in parallel with general or specialized functions.

The server 104 contains a user access database 107 that stores login information and user access rights and privileges. Each user of the system, including administrators, teachers, and students, have a unique user ID. This user ID is associated with certain rights and privileges, such as the ability to access certain content stored on the server component 104. Users may be defined by general predetermined profiles, such as student or teacher. A general profile would include certain rights and privileges for an entire set of users. For example, the teacher group would be granted access to certain reporting tools. These general profiles may be further differentiated, so that a single user may be given unique access rights. For example, a particular student's ID may be granted permission to access a feature of their mobile device, such as text messages or music downloads.

The server 104 also stores a problem set repository 105. The problem set repository 105 contains problems aligned by lesson plan unit and correlated by state standards or other applicable education standards. Problems in the problem set repository 105 can be presented in a simple format such as text or HTML, or in multimedia format such as MP3, MP4, Java, Flash, or other formats. Mixed-media formats may also be used.

An e-content repository 106 stored on the server 104 contains digital snippets. Digital snippets are supplementary instructional resources that assist a student with learning content required to solve the problem set. Digital snippets include multimedia content related to particular lessons and can be in the form of documents, pictures, audio and video in various formats including, for example, MP4, MP5 or Java. The content of a digital snippet may include a review of the lesson plan, example problems, or a video walkthrough of a problem solving-strategy. Digital snippets may or may not have input requirements, and can be added to the e-content repository by teachers, administrators, or students. In an embodiment, e-content submitted by students is queued for teacher or administrator review prior to becoming viewable by other students.

The server 104 also provides content filtering capabilities. All access to the web by the student component is routed through a content filter 108. This includes web requests received from a device connected via a wi-fi network, as well as web requests received from a device connected via a cellular data network or other internet-enabled network. Content, such as text or images uploaded by the students, is filtered based on predefined terms. Instant messages are also filtered based on predefined terms. The content filter can be configured to send a notification to a teacher or administrator when a student attempts to breach a use policy. The content filter 108 can also provide a teacher or administrator with access to logs of content uploaded by students. In an embodiment, the content filter 108 can delay publishing any uploaded content until it is approved by a teacher or administrator.

The server 104 contains a rewards component 110 for granting student access to rewards according to teacher-defined parameters. The rewards component 110 tracks student progress and points received. The rewards component 110 enables students to redeem points for services available on the wireless mobile device. Specific rewards include additional talk minutes, text messaging, web access, music/video downloads, and ringtones.

FIG. 1 shows the administration computer 301. The administration computer 301 can be a desktop or laptop PC, a thin client, or any other computer or device capable of displaying the administrator tools. The working environment could be available as a native application, or through a web browser such as Internet Explorer or Firefox. The administration computer connects to the server 104 via an interne connection 303 or any other suitable connection type.

The administration computer 301 provides an administrator with a user access tool 304 that allows an administrator to add or edit the user access information stored on the server 104. The user access tool enables delegated administration of the user access database 107 so that central administrators may delegate permissions to school site administrators to add, change or delete user account settings. System administrators can also use the user access tool 304 to monitor or change user permissions. Through this tool administrators can enable and disable features including, but not limited to, two-way communications, text messaging, or the use of a camera on the mobile device. Administrators can also monitor the devices in real-time, or set restrictions on what time of a day a device may be used.

The administration computer 301 also provides a monitoring tool 305. The monitoring tool 305 allows an administrator to view reports from the content filter 108, including instances in which a user attempted to access blocked content. The monitoring tool 305 also allows the administrator to review content generated by students such as text messages, blog postings, or chat conversations. In an embodiment, the monitoring tool 305 allows an administrator to approve content uploaded by a student before it is publicly posted. Uploaded content is held in the content filter 108 on the server 104. The monitoring tool 305 enables an administrator to view that content and approve it for publishing on the network.

FIG. 1 illustrates a teacher computer 201. The teacher computer 201 can be a desktop or laptop PC, a thin client, or any other computer or device capable of accessing a web services framework. The working environment could be available as a native application, or through a web browser such as Internet Explorer or Firefox. The teacher computer connects to the server 104 via an internet connection 203.

The teacher computer 201 provides a teacher with problem set selection and rating functionality via a problem set tool 204. The teacher computer 201 connects to the problem set repository 105 on the server 104 and provides the teacher with a list of available problems that are aligned by lesson plan unit and correlated by state standards. A teacher can view the problem set in a preview tab that shows what the problem will look like on a student's mobile device. The preview tab includes an emulator that provides access to the full functionality of the wireless device on the teacher computer 201. This allows the teacher to view and interact with a problem as it would be viewed and interacted with by the student. If more than one problem set exists for a particular lesson plan, the teacher can select one problem set from the list, and assign it to students. In an embodiment, the problem set tool 204 enables teachers to rate problem sets, as well as view the ratings of other teachers.

The teacher computer 201 also provides a teacher with access to the e-content repository 106 stored on the server 104. The e-content tool 205 allows the teacher to view digital snippets associated with a particular lesson plan, and select which content will be available to students attempting to solve a problem set. Teachers can view the digital snippets in a preview tab that shows what they would look like on a student's mobile device. The e-content tool 205 also allows teachers to create and submit their own digital snippets, or provide feedback by rating snippets submitted by others based on, for example, the quality of information, quality of documentation, and relevance to the problem. Digital snippets can be sorted by resource name, description, submitter, date, or rating. Teachers can also view an e-content report that shows the details of the e-content has been viewed and visited by each student, including the number of visits. The report can be downloaded for later viewing in, for example, an excel format.

The teacher computer 201 provides access to a monitoring component 206 that allows teachers to track students along multiple strands. The teacher can track mastery of the lesson plan unit determined by the students' ability to solve for the problem of the week. The teacher can also access statistics related to student utilization rates. These statistics track, among other things, which parts of the system students most regularly utilize. The teacher monitoring component 206 allows the teacher to correlate data regarding the utilization rates of the individual students and components they are more readily using with student achievement results. A parent reporting component 207 accessible via the teacher computer 202 allows the teacher to communicate weekly assessment results to parents.

The monitoring component 206 in the teacher computer 201 can perform the functions of the monitoring tool 305 in the administrator computer 301. Thus, the monitoring component 206 allows a teacher to view reports from the content filter 108, including instances in which a student attempted to access blocked content. The monitoring component 206 also allows a teacher to review and edit any content generated by students including text messages, blog postings, chat conversations, or e-content submissions. In an embodiment, the monitoring component 206 allows a teacher to approve content uploaded by a student. Uploaded content is held in the content filter 108 on the server 104. The monitoring component 206 enables a teacher to view that content and approve it for publishing.

The teacher computer 201 provides a rewards tool 208 that enables a teacher to view and set the amount of points awarded for particular student activities. Students may receive points for activities such as logging into the system, solving a problem correctly, volunteering as a student mentor, uploading relevant content, or other helpful acts. The rewards tool 202 enables a teacher to determine what rewards are available and how many points must be exchanged for each reward.

Though the teacher computer 201, the administration computer 301 and the server 104 are illustrated in FIG. 1 as three separate machines, one of skill in the art would recognize that any or all of the components could be provided on the same computer. A single computer could function as the teacher computer, the administration computer, and the server, or any sub-combination of those components.

A wireless mobile device 401 provides students with access to educational content. The wireless mobile device 401 can be any mobile device capable of wireless communications, such as a Pocket PC smartphone running Microsoft Windows Mobile. The wireless mobile device 401 connects to a wireless access point 403, and the wireless carrier 404 provides a connection to the Internet, which enables communication with the server 104. The student must log into the system using a user name and password or other authentication system, such as a biometric system. In an embodiment, the specific device assigned to the designated student will require only a password after the first login. The device itself must also be authenticated. To that end, a security certificate is installed on the wireless mobile device 401, which authenticates with the server 104 to ensure that the device is authorized. The two levels of security ensure that only authorized users on authorized devices are able to access the system. Thus, the communication platform is only accessible by students and their teachers, parents, or administrators.

The wireless mobile device 401 provides the student with access to the problem set 405 assigned by the teacher. The student is able to review the problem, and either solve it or choose to access various forms of help. If the student successfully solves the first problem of the problem set 405, they will be presented with one or more follow-up questions that asks the same questions with different parameters. If the student requests help, the student can use the supplemental resources tool 406 to access digital snippets made available by the teacher. The student can also access a peer-to-peer collaboration component 407 with social networking tools including blogs, wilds, and instant messaging. The collaboration component 407 is a closed secure environment only accessible by users who have been given access rights and privileges. Students have access to an authoring and editing tool to allow them to post content via the wireless mobile device 402. Individual communities are formed for each problem that is assigned. All content submissions are stored within the community established for a specific problem, and students can go back into the system to utilize previously submitted content to assist them in maintaining mastery of the lesson plan unit and allow future students to build upon content already created. Students may also volunteer as a student mentor to assist other students in learning the tools necessary to solve the problem set.

The wireless mobile device 401 also provides the student with access to the student rewards tool 408. The student rewards tool 408 enables the student determine their current point totals and allows them to redeem points for services available on the wireless mobile device 401. Specific rewards include additional talk minutes, text messaging, web access, music/video downloads, and ringtones.

FIG. 1 also shows the parent computer 501. The parent computer 501 can be a desktop or laptop PC, a thin client, or any other computer. The working environment could be available as a native application, or through a web browser such as Internet Explorer or Firefox. The parent computer 501 connects to the server 104 via an Internet connection 503 or other suitable connection.

The parent computer 501 includes a parent reports tool 504 for viewing student information sent to the parent by the teacher. Through this tool, the parent can also view recommendations from the teacher on different exercises to work with electronically or in print form. The parent computer 501 also includes a messaging tool 505 for sending information to the teacher.

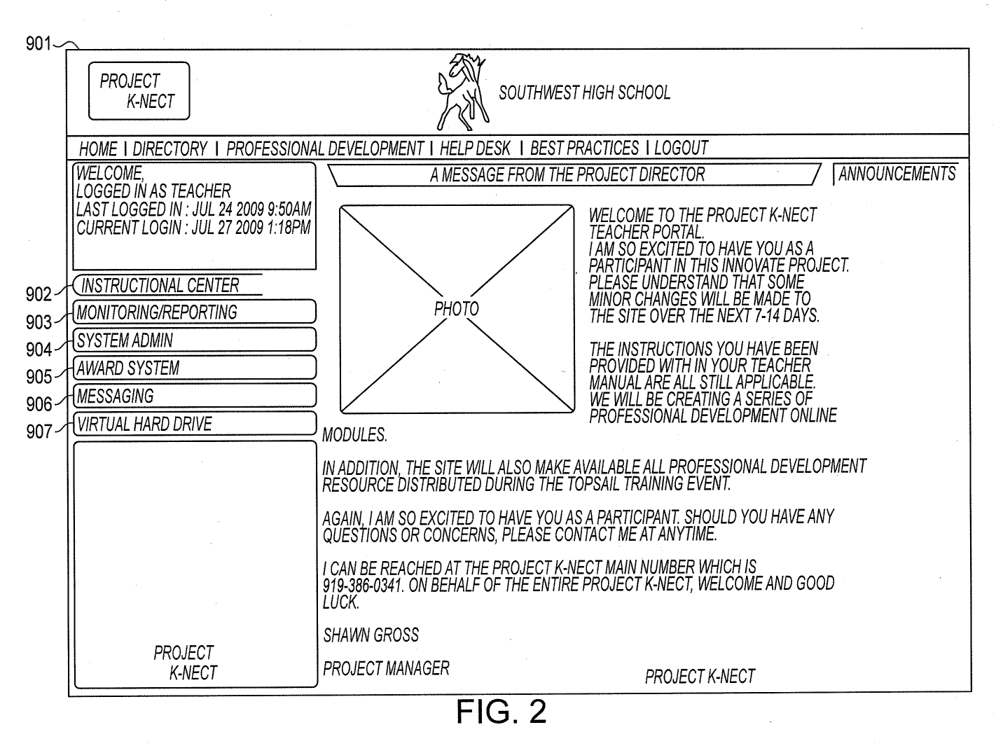

FIG. 2 is an illustration of the teacher homepage 901 that provides access to the various functions of the teacher computer 201. The “Instructional Center” link 902 provides access to the problem set tool 204, and the e-content tool 205. The “Monitoring/Reporting” link 903 provides access to the monitoring component 206. The “System Admin” link 904 provides the teacher with access to the administrative tools of the administration component 305. The “Award System” link 905 provides access to the rewards tool 208. The “Messaging” link 906 enables the teacher to communicate with students, parents, and administrators, and the “Virtual Hard Drive” link 907 enables a teacher to store files on hard drive space located on the server 104. The teacher homepage 901 can be configured to display graphs and charts showing statistics related to overall student progress. The homepage 901 can also be configured to display an instant messaging client or an announcements panel.

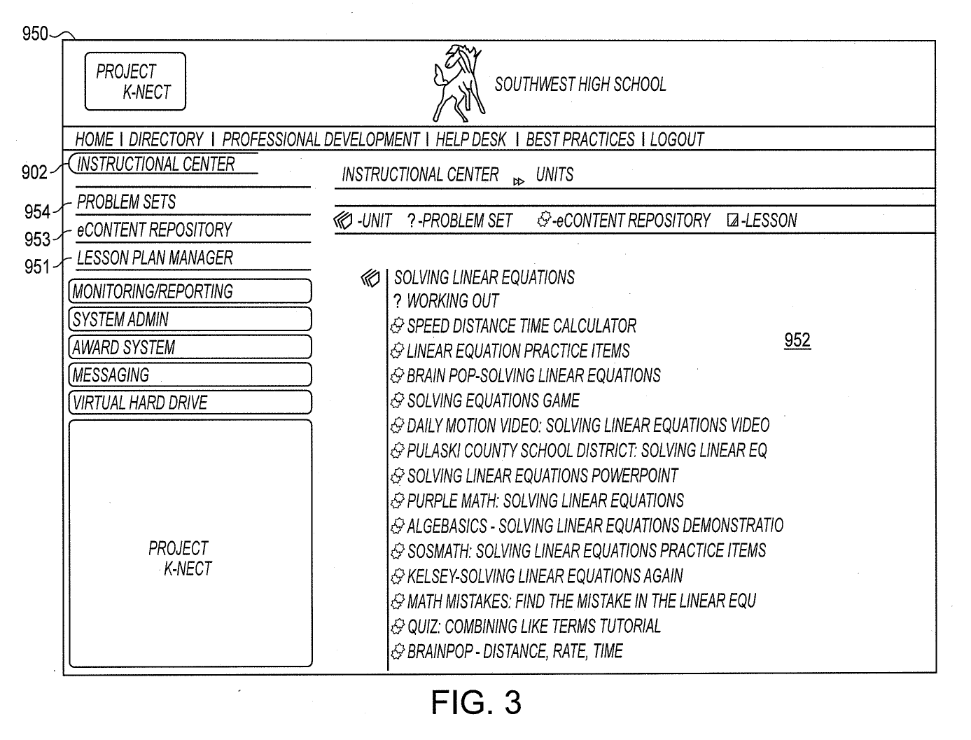

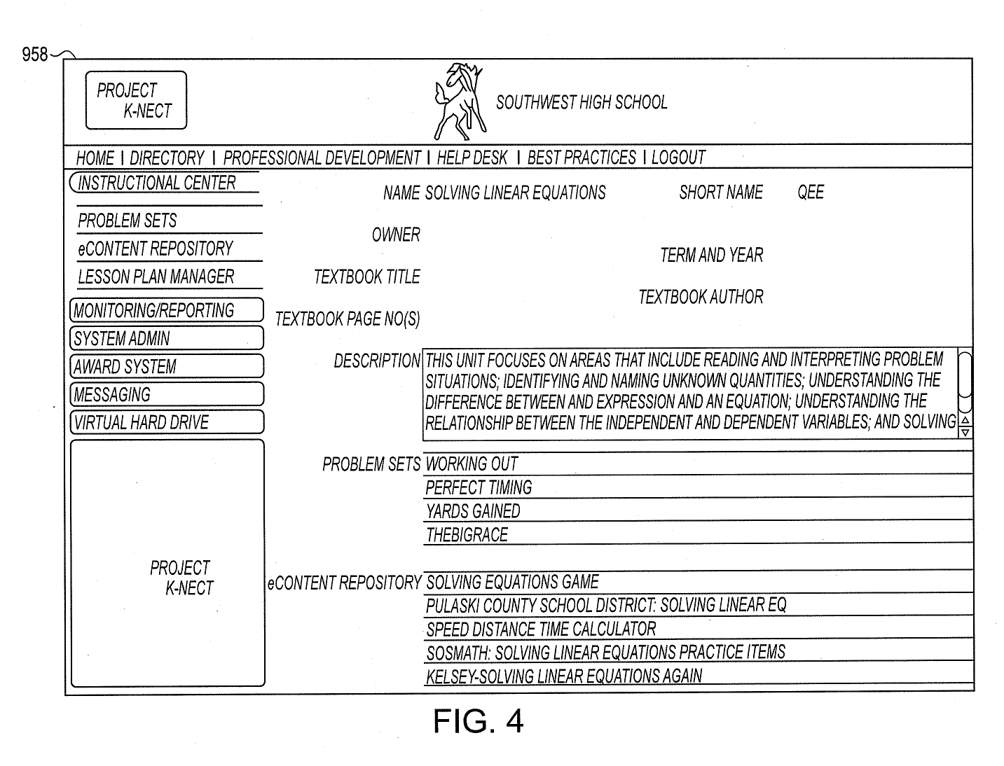

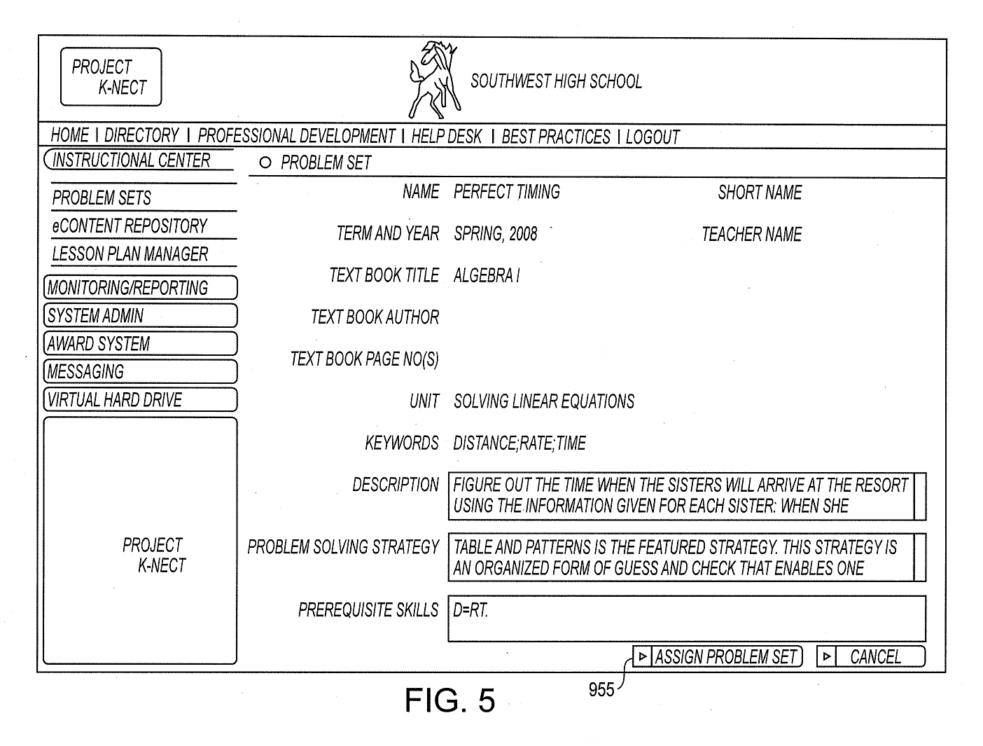

FIG. 3 illustrates the Instructional Center homepage 950, accessed by clicking the “Instructional Center” link 902 on the teacher homepage 901. The Instructional Center homepage 950 provides access to the problem set tool 204 and e-content tool 205, as well as a lesson plan manager 951. In the main panel 952, problem sets are organized by unit, and paired with associated e-content repositories. A teacher may select a particular unit to view details on the unit, such as the name, associated textbook, description, available problem sets or e-content, and prerequisite skills, as illustrated in the unit screen 958 shown in FIG. 4. Similarly, selecting a problem set provides details on the problem set including the name, teacher name, unit, description, problem solving strategy, or prerequisite skills, as illustrated in FIG. 5. Selecting the “Assign Problem Set” link 955 on the problem set page allows the teacher to assign a problem set to particular students, or all students. In an embodiment, the teacher can select a start and end date for a particular problem set. Once assigned, the problem set will be pushed to the student's wireless mobile device 401 the next time the device connects to the server 104.

Turning again to FIG. 3, the “eContent Repository” link 953 on the Instructional Center homepage 950 accesses the e-content tool 205. Using the e-content tool the teacher can view, add, or rate e-content. Selecting the “Lesson Plan Manager” link 951 accesses education resources such as teaching strategies, preparation required for a lesson, and other information related to a lesson. Lesson plans can be organized by unit according to applicable state standards or other education standards.

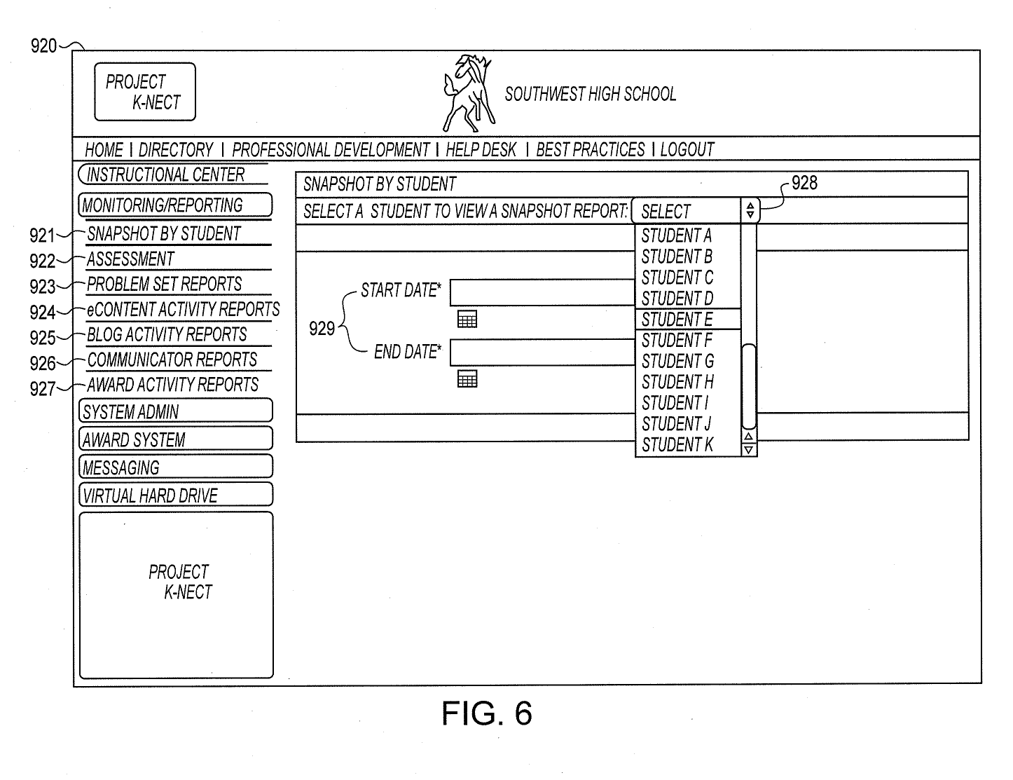

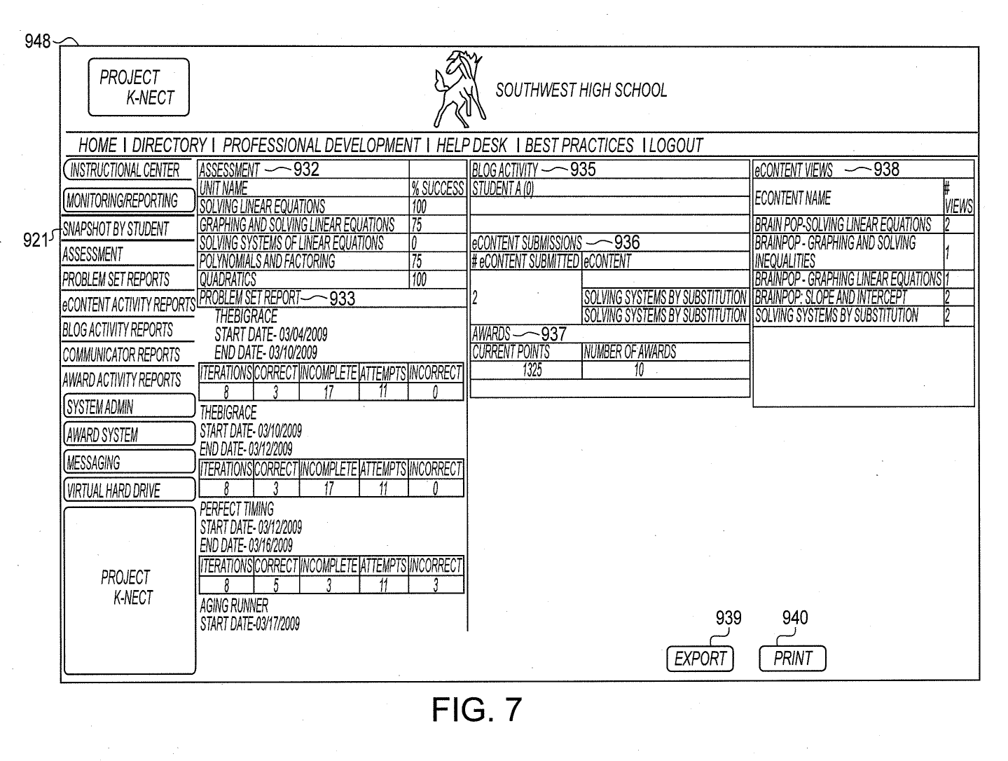

FIG. 6 illustrates the Monitoring/Reporting homepage 920, which provides access to functions of the monitoring component 206. The default screen for the Monitoring/Reporting homepage is the “Snapshot By Student” screen, which can be accessed at any time via the “Snapshot By Student” link 921. To request a report, a teacher selects a student name using the dropdown list 928, and selects date range using date fields 929. As illustrated in FIG. 7, the system generates a consolidated report of all the activities undertaken by a particular student in a given period of time providing teachers with valuable information about the student. The snapshot includes an assessment 932, a problem set report 933, a blog activity report 935, e-content submissions 936, awards 937, and e-content views 938. Teachers can export the report to an excel file using the “Export” button 939 or print the report using the “Print” button 940.

Selecting “Assessment” 922 from the Monitoring/Reporting homepage 920 illustrated in FIG. 6 accesses the problem set tool 204 and the monitoring component 206 shown in FIG. 7. The problem set tool 204 provides information on the progress of all students with respect to the units assigned by a teacher. The problem set tool 204 allows a teacher to assign follow-up problems. In an embodiment, when a teacher assigns follow-up problems aligned to a unit, a set of four problems will be assigned to the selected students. Among the set of four problems, the first three problems will be randomly picked and the fourth one will be the first problem aligned to the unit selected. Thus, no student will receive the same three problems except the fourth one which will be the same for all the students. The problem that is the same for all students will be the first problem aligned to the unit.

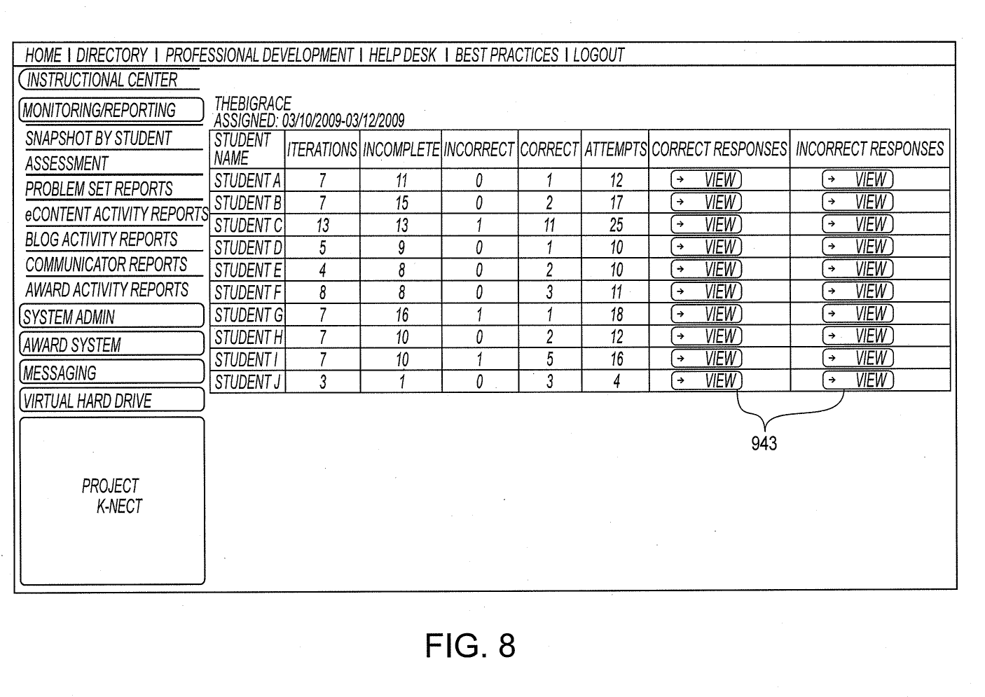

Selecting “Problem Set Reports” 923 from the Monitoring/Reporting homepage 920 illustrated in FIG. 6 accesses additional reports on student progress through particular problem sets. As shown in FIG. 8, the reports include the number of iterations made by students in solving the problem, the number of times e-content is used by students, the total number of attempts made by a student in solving the problem, the number of correct responses, and the number of incorrect responses. Reports are generated by analyzing files uploaded to the server 104 by a student's wireless mobile device 401. When students download a problem set to the wireless mobile device 401, all inputs by the student solving the problem set are recorded locally on the device in a specified folder utilizing, for example, an XML based file format. When a student's wireless mobile device 401 connects to server 104, the XML file is uploaded and parsed to produce the reports shown in FIG. 6. Selecting the “view” buttons 943 allows a teacher to view the correct and incorrect responses entered by a student.

Selecting “eContent Activity Reports” 924, “Blog Activity Reports” 925, or “Communicator Reports” 926, from the Monitoring/Reporting homepage 920 illustrated in FIG. 6 accesses reports on student usage of the e-content, blogs, and communicator, respectively. In these reports, the teacher can view statistics for individual or classroom usage of the features, as well as view logs that display, for example, individual chat histories or blog and e-content submissions. Selecting “Award Activity Reports” 927 from the Monitoring/Reporting homepage 920 accesses reports on points achieved by students in the number of awards.

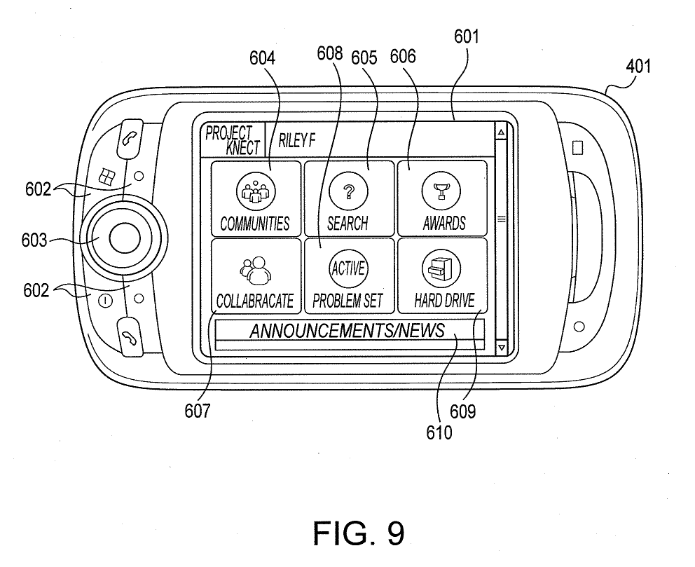

FIG. 9 is an illustration of a wireless mobile device 401 constructed in accordance with an embodiment described herein. The device shown is a Pocket PC smartphone, but any wireless mobile device can be used, including any cellular telephone, smartphone, or internet-enabled mobile wireless device. The wireless mobile device 401 in FIG. 2 utilizes a touchscreen 601, several hardware buttons 602, a directional pad 603, and an optional slide out qwerty keypad (not shown) for input, but any input method or device can be used, such as a T9 keypad or trackball. In the wireless mobile device 401 shown in FIG. 2, the touchscreen 601 enables selection of graphical user interface (GUI) elements. The hardware buttons 602 control functions including power on and off, start and end call, and context specific functionality. The directional pad 603 enables movement of a cursor element. The wireless mobile device 401 is capable of displaying images, text, or movies, and playing audio. The wireless mobile device 401 connects to the Internet via an Evolution Data Optimized (EV-DO) signal, but any wireless signal providing internet access would be sufficient. Faster internet connection speeds permit greater use of multimedia content such as audio and video.

In an embodiment, the wireless mobile device 401 offers rewards enabling certain of the wireless mobile device's features. Students can earn reward points for logging into the system, solving problems, posting useful content, helping other students by acting as a student mentor, or other actions. Students can then redeem these points for device-based rewards. Example rewards include additional cellular minutes, the ability to send text messages, music downloads, video downloads, games for the device, and allocation of minutes to browse the internet. These rewards can be enabled or disabled by the teacher or the administrator.

In an embodiment, the wireless mobile device 401 device has local storage for storing information when a connection to the Internet is unavailable. Weekly content available to the students can be downloaded onto the device and stored in local memory. If the user is disconnected from the network, the device will store the data in local memory to avoid the potential for data loss. Optionally, a reconnected user can be returned to the active screen they were working on when the network was disconnected. The local storage can also be used to store XML files that record any user input on the device. These files are uploaded to the server and analyzed in order to provide a teacher with various usage reports. These reports can be used by the teacher to analyze a student's problem solving strategy, as well as monitor usage of communications elements.

In an embodiment, the wireless mobile device 401 includes a camera. The camera is used to take pictures that can be uploaded to blogs or messages via the peer-to-peer collaboration tools. Additionally, the ability to take pictures can be offered as a reward redeemable with reward points.

In an embodiment, the firmware of the wireless mobile device 401 is installed with a security certificate. The security certificate can be installed remotely via the administrator m module 301. The security certificate is used to authenticate the wireless mobile device 401 when the device is connected to the server 104. This ensures that only authorized devices are able to access the network. The security certificate can be used in conjunction with other protocols, such as a user name and password authentication system, to provide additional layers of security.

FIG. 9 shows the welcome screen on an embodiment of the wireless mobile device 401. This screen is displayed after a student has turned on the device and logged in. The student's name is displayed on the welcome screen. The student can select operation modules by selecting the buttons labeled “Communities” 604, “Search” 605, “Awards” 606, “Collabracate” 607, “Problem Set” 608 and “Hard drive” 609. The buttons 604-609 can be selected via the touch-screen 601 or the directional pad 603. From the welcome screen, a student can also view announcements or news 610 posted by a teacher or administrator.

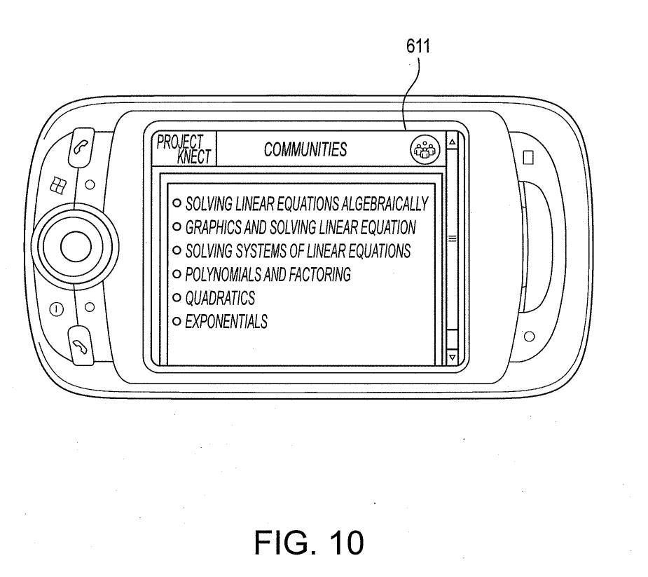

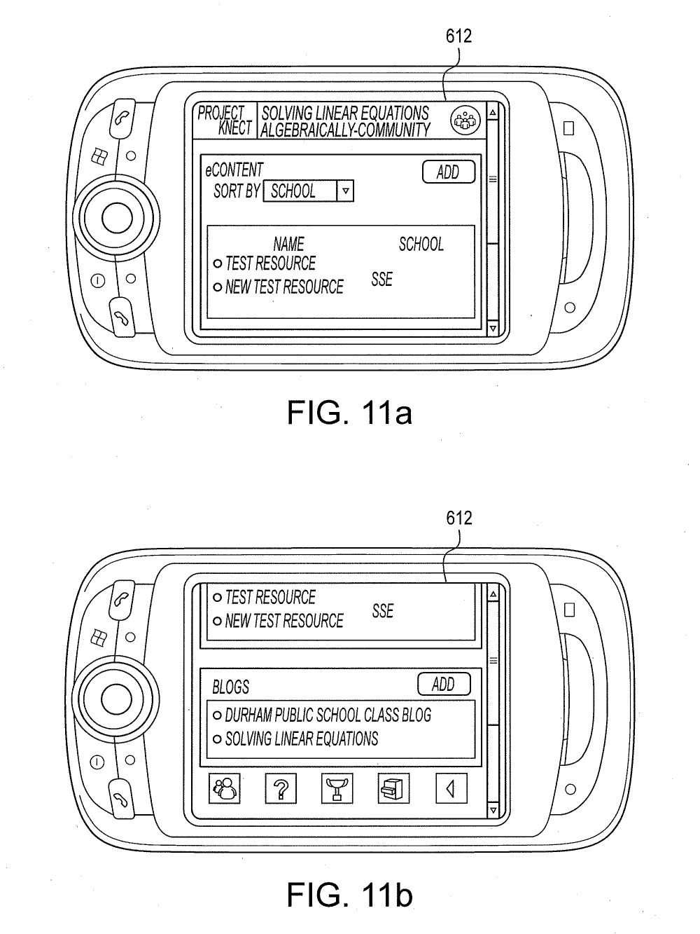

The “Communities” module enables groups of students and tutors to communicate and share information useful for solving the problem set. The “Communities” screen 611 is illustrated in FIG. 10. Communities are aligned with course units and every unit has a corresponding community. Each community includes blogs dedicated to, for example, a particular class or unit, as well as e-content related to, for example, a unit or problem. When a student selects a particular community, they are presented with the screen 612 illustrated in FIGS. 11a (showing the available e-content) and 11b (showing the available blogs). In the e-content module, a student can view and sort information based on e-content name, author, school, rating, file type and date submitted. Students can also add new e-content in the form of documents (for example, text, word or pdf files), audio, video (mp3 and mp4 files) and they can also rate the information provided in the e-content library. E-content files can also be saved to local storage for offline viewing. In the blog module, students can add blog entries to existing communities, comment on blog entries by other students, or upload reference documents, pictures, audio video files, and also report abuse. Unit blogs are associated with each unit and are for sharing knowledge for a specific unit. In an embodiment, there is a global social blog, where students and tutors can share opinions, insights, experiences, and perspectives. The social blog is associated with and accessible from any of the unit communities.

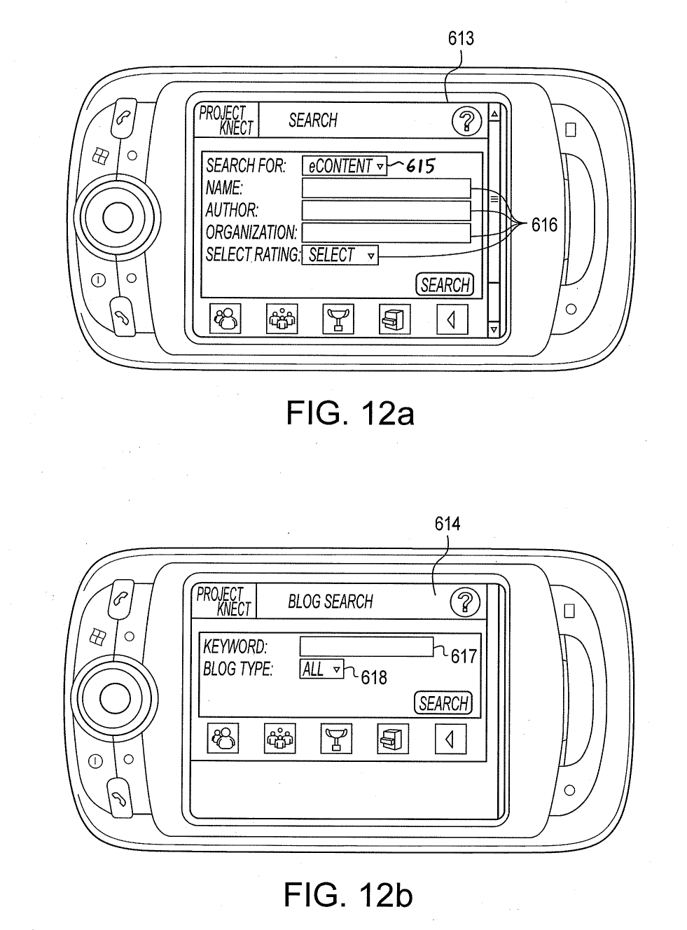

Returning to FIG. 9, the “Search” module 605 enables a student to search for content in the e-content repository or on the blogs. The “Search” screen is illustrated in FIGS. 12a and 12b. FIG. 12a shows an e-content search screen 613, and FIG. 12b shows a blog search screen 614. A student can search the e-content library by selecting “e-content” from the “Search For” dropdown list 615 and entering terms into data entry fields 616 that search by name, author, organization (such as school name, for example) or rating. A student can search blog content by selecting “Blog” from the “Search For” dropdown list 615 and entering search terms into the keyword text box 617, as illustrated in FIG. 12b. The “Blog Type” option 618 allows a student to search for blogs related to a particular school, unit, or author.

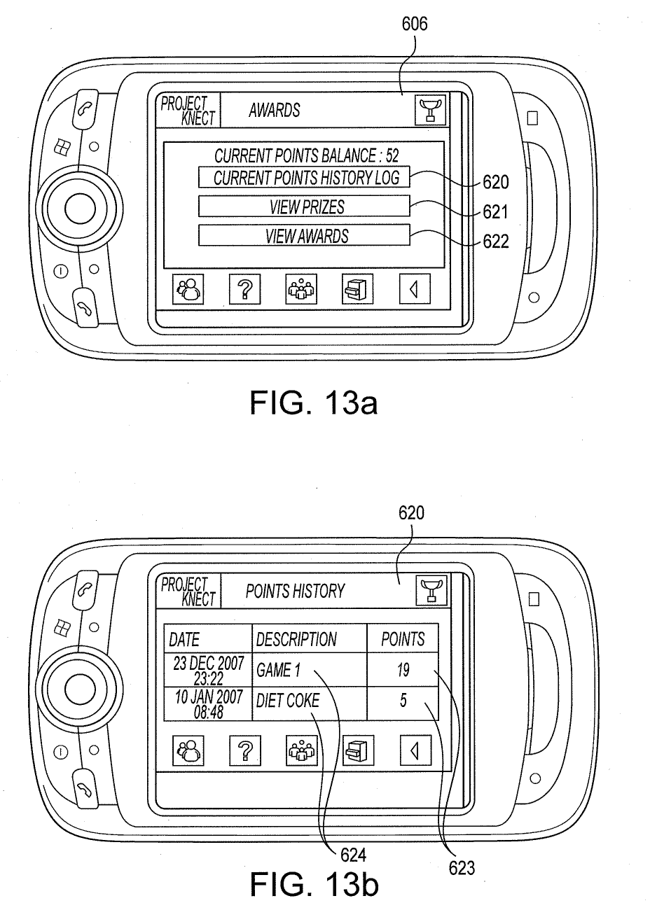

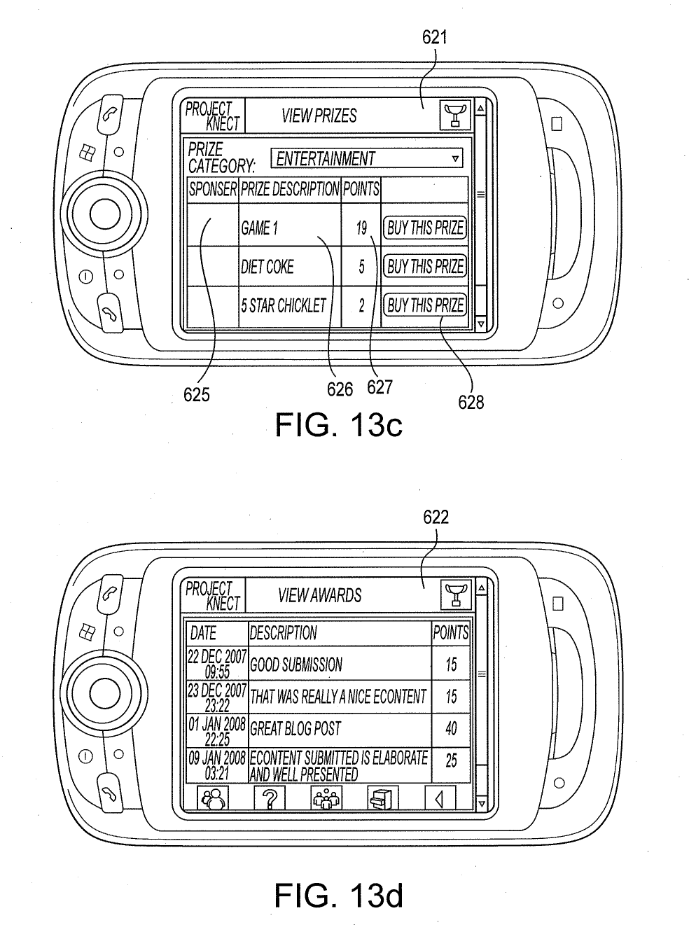

The “Awards” module 606, illustrated in FIGS. 13a-13d, provides access to the rewards system, where a student can view their accumulated points and exchange them for rewards. FIG. 13a illustrates the options available to a student in the “Awards” module 606. The Student can view a current points history log 620, view prizes 621, or view awards 622. The current points history log screen 621, illustrated in FIG. 13b, shows points 623 redeemed by students and the prizes 624 those points were exchanged for. Selecting “view prizes” enables a student to view prizes by category. In FIG. 13c, as an example, the prizes 624 in the entertainment category are shown. The display shows the prize sponsor 625, if any, the prize description 626, and the amount of points required to purchase a prize 627. The student can purchase prizes with points by selecting “Buy this prize” 628. FIG. 13d illustrates the “view awards” screen 622. If a students selects “view awards,” they are shown how many award points have been awarded to them on their various submissions. Submissions can include e-content, a solution to a problem set, or a solution to follow-up problems, as examples.

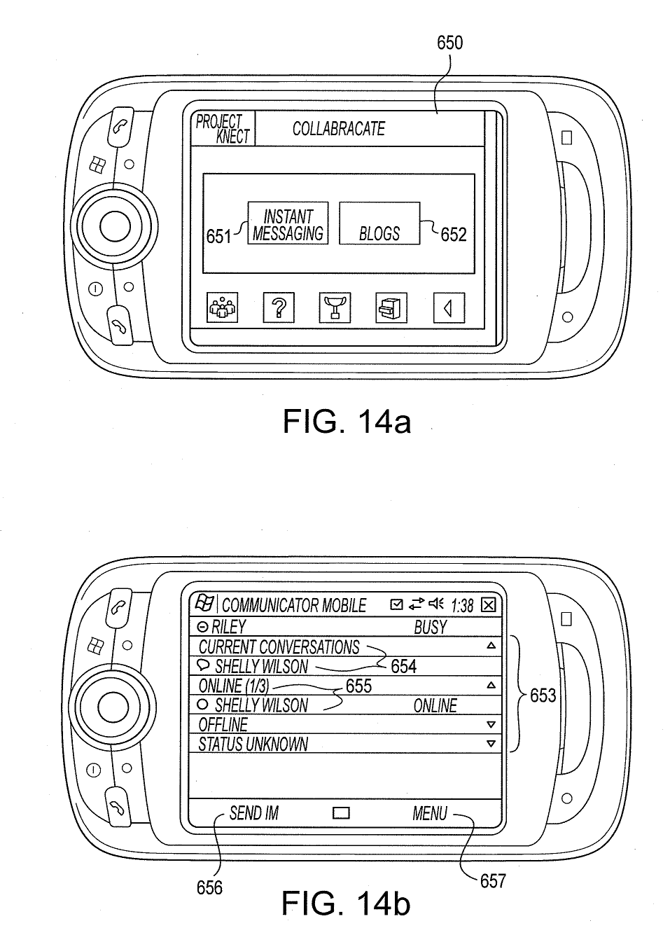

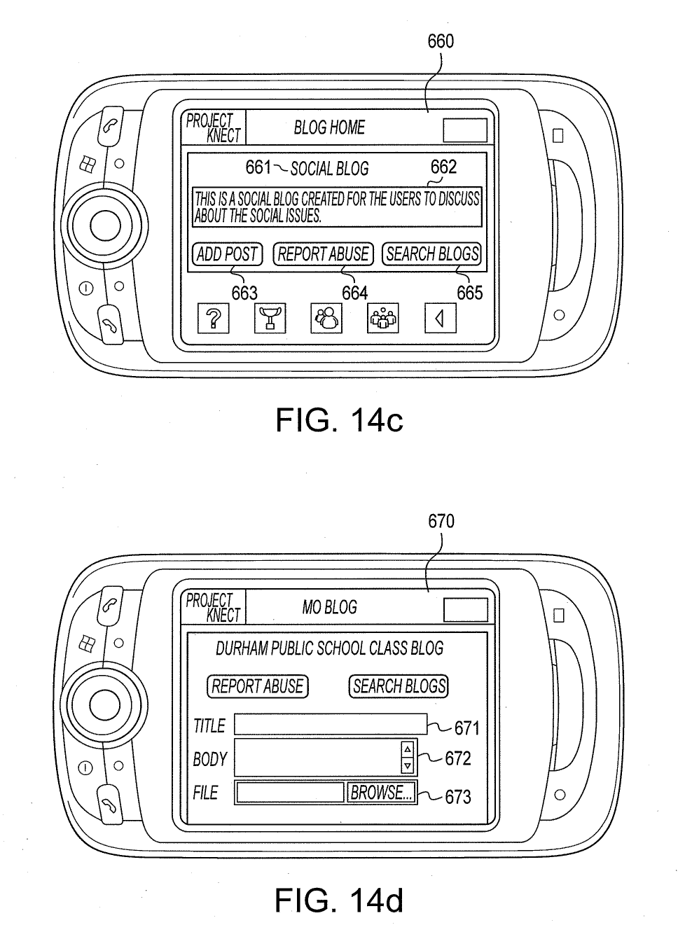

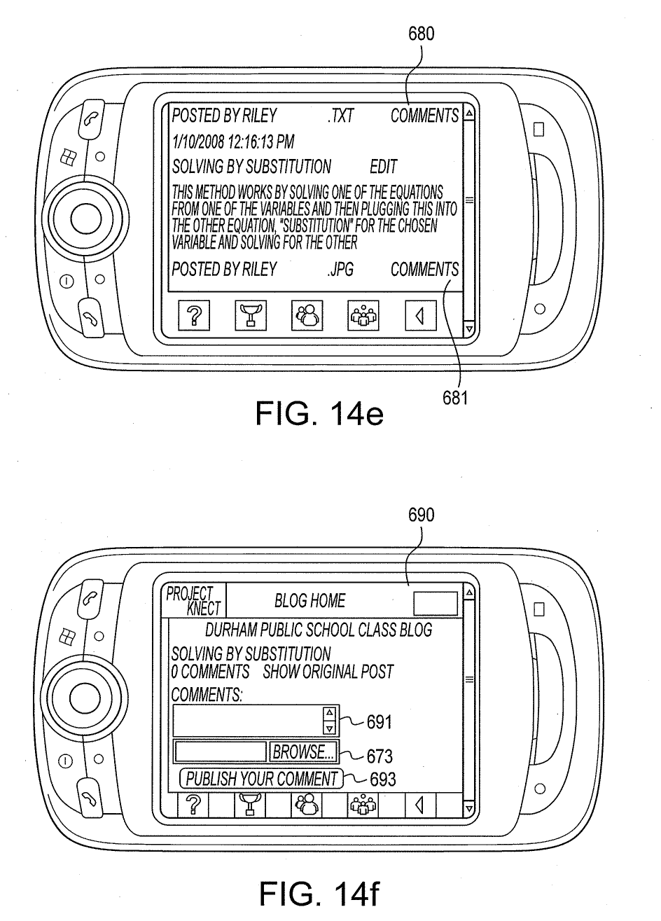

The “Collabracate” module 607 shown in FIG. 9 is illustrated in more detail in FIGS. 14a-14f. Collabracate enables students to interact with each other, via blogs and instant messaging. FIG. 14a shows the main collaboration screen 650, which provides a student with access to instant messaging or blogs. The instant messaging option 651 enables a student to communicate in real-time with one or more peers. The instant messaging module, illustrated in FIG. 14b, presents a student with their contact list 653, which indicates the status of their contacts. Selecting an entry under “current conversations” 654 returns the student to an ongoing chat conversation. Highlighting an entry under the online users 655 heading and selecting “Send IM” 565 allows a student to initiate a new instant messaging conversation. The instant messaging client includes a full suite of instant messaging options, including adding or removing contacts, blocking users, status updates. These options and other management options are available through the menu icon 657. As shown in FIG. 14b, Microsoft Communicator Mobile can be used for the instant messaging client. In an embodiment, all communication within the instant messaging module is logged and uploaded to the server 104 for review by the teacher.

The blogs option 652 in the “Collaboracate” module 607 provides access to a school blog. In the school blog, both students and tutors can view and post information related to their class or school. Students can publish new posts, which can include text or media files, and can also comment on existing posts made by other users. FIG. 14c shows an example blog screen. When a user selects a blog, the blog welcome screen 660 provides the student with title 661 and a description 662 of the blog. A student can select “Add Post” 663 to add a new post, “Report Abuse” 664 to report a violation of use standards, or “Search blogs” 665 to search for content on the blogs. If the student selects “Add Post” 663, they are presented with the post screen 670 illustrated in FIG. 14d. Here, the student can enter a new blog post by typing a title into the title field 671 and content into the body field 672. The student can also upload a related file from local or virtual hard drive storage by selecting the “Browse” button in the file field 673. FIG. 680 illustrates an example blog post screen 680, as viewed on the mobile wireless device 401. Selecting the “Comments” link 681 enables the student to access and post comments. FIG. 14f illustrates the comments screen. From here, the student can publish a comment on a blog post by entering information into the comments text field 691, optionally uploading a file using the “Browse” button in the file field 673, and selecting the “Publish Your Comments” button 693.

Selecting “My Hard Drive” 607 from the welcome screen illustrated in FIG. 9 enables students to access a virtual hard drive in which they can store and access files from home, a local library, or anywhere with access to the Internet. Storage for the virtual hard drive is provided as a shared resource on the server 104. Files can be uploaded from the local storage on the wireless mobile device 401, to be viewed or accessed at a later time. Students can organize their virtual hard drive by creating folders and subfolders, and can share files with other students by setting access permissions on the various folders or subfolders.

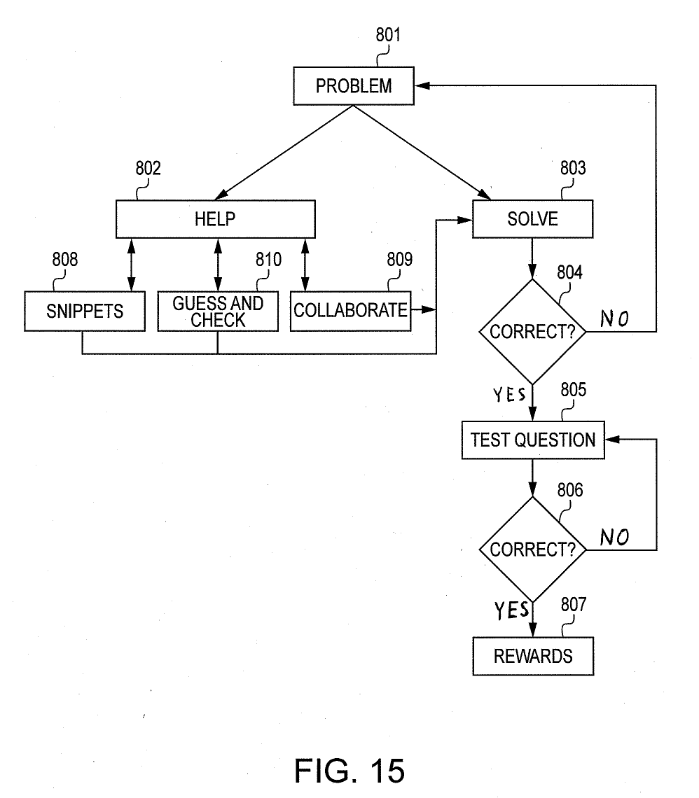

Selecting “Active Problem Set” 608 from the welcome screen illustrated in FIG. 9 accesses the current problem set assigned to the student. FIG. 15 is a flow chart displaying the basic problem set methodology. When the student selects the problem set link from the welcome screen, they are presented with a problem 801. The problem can be in various media or multimedia formats. After being presented with the problem, the student can either obtain help 802 or attempt to solve the problem 803. If the student selects help 802, they will have the option of viewing digital snippets 808, accessing the peer-to-peer collaboration module 809, or using a guess and check tool 810. After viewing help content, the student is given the option to either view more help content 802 or solve the problem 803. At step 804, if the problem is not solved correctly, the student will be returned to step 801, where they will have the option of either obtaining further help 802 or making another attempt to solve the problem 803. If the problem is solved correctly at step 804, the student is presented with a second test question that asks the same type of question but with different parameters. Step 805 ensures mastery of the still set and reduces the possibility of cheating. If the student answers incorrectly at step 806, they are returned to the test question. The student could alternatively be returned to the main problem step 801, or the help step 802 (not shown). If the student answers correctly at step 806, a rewards screen is displayed (step 807).

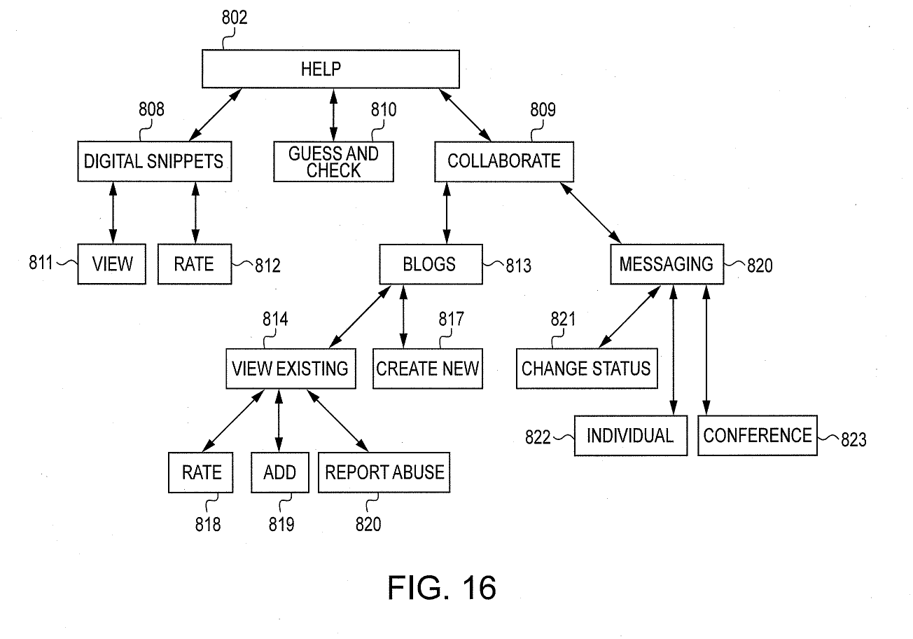

FIG. 16 is a flow chart illustrating the options available in the help module. Upon selecting the help option 802 from the main screen, the student is presented with the option of viewing digital snippets 808, accessing a guess and check tool 810, or accessing the peer-to-peer collaboration module 809.

A student choosing to view digital snippets 808 will be presented with multimedia content relating to the lesson plan associated with the problem set. Students can view individual snippets 811 and rate them 812. In an embodiment, the ratings are aggregated and can be viewed by students browsing available digital snippets. After viewing this content, the student will have the option of attempting to solve the problem of the week (not shown) or returning to the main help screen 802.

A student choosing to access the guess and check tool 810 will be able to use the tool to enter a guess answer. The guess and check tool 810 will then use these values in the context of the problem, and present results to the student. For example, the guess and check tool 810 may simulate the results of a student's guess. The student will then be able to determine whether the parameters they entered were correct. The guess and check tool 810 can guide the student to a correct answer, by presenting, for example, example equations that could be used in place of guessing.

A student selecting the peer-to-peer collaboration module 809 from the main help screen 802 is presented with the option of accessing blogs 813, or the messaging system 820. If the student chooses to access blogs 813, they may either view existing blogs 814 or create a new blog 817 using authoring tools. Student-created blogs can contain text, picture, and video content related to the current lesson plan. Individual communities can be formed for each problem that is assigned, and all content submissions to the site can be stored within the community established for the specific problem. This allows students to go back into the system to utilize previously submitted content to assist them in maintaining mastery of the lesson plan unit. Future students can build upon content already created. When viewing blogs, the student is given an option to rate the blog 818, or add content 819, such as a comment. The student can also report abuse 820 if they encounter content that does not comply with the terms of use. When creating their own blog 817 the student can upload content relevant to the current lesson plan. All uploaded content is passed through the content filter on the server. Additionally, all content can be reviewed and edited by a teacher utilizing the teacher monitoring tools 206.

If a student selects the messaging system 820, they are presented with three options. The student has an option to change their status 821 to anonymous. Thus, a student has the option of entering the messaging system anonymously, though the administrator will always be able to trace the identity of the end user. A student can also enter into individual 822 or conference 823 messaging. This allows the student to communicate in real-time via chat or instant message with one or more other students. As with all other content uploaded by students, the upstream messages are passed through the content filter on the server, so that they can be monitored by teachers and administrators.

Though FIG. 16 displays blogs and chat as two options in the collaboration component, other social networking functionality can be implemented in this component, including wikis, interactive whiteboards, and message boards.

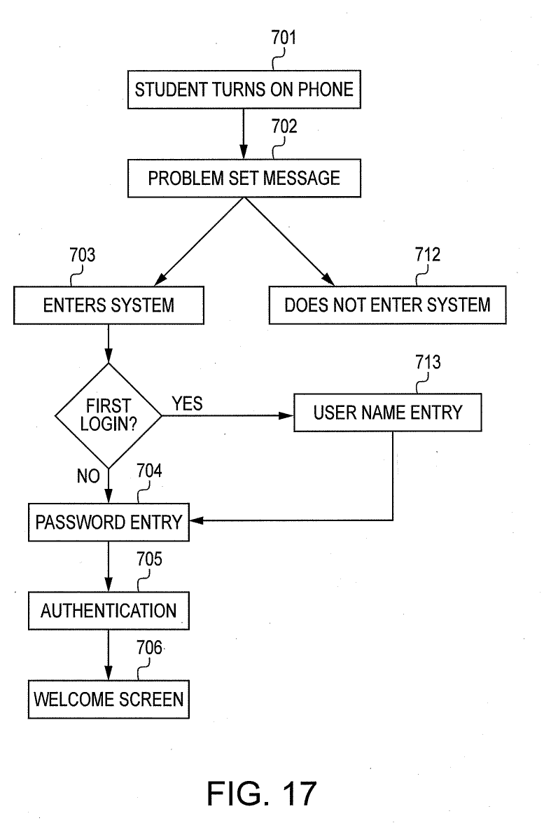

FIG. 17 is a flow chart displaying an example authentication procedure for the wireless mobile device 401. First, the student turns on the phone 701. If a problem set has been assigned by the teacher, the student will be presented with a message 702 indicating that a problem set is available. At this stage, the student can either enter the system 703, or turn off the phone 712. The first time that the student enters the system, the student will be prompted to enter a user name 713, and then a password 704. If, however, the student has already logged in, the device will have already stored the user name in local memory. Thus, the student need only enter a password 704. Next, the student is authenticated 705 against a directory with a password and mac address for the device. If authentication is successful, the user is presented with the welcome screen 706. As described above, each student can have a different access profile, providing the students with different levels of access to certain device features, such as the ability to use the communications modules or camera functionality.

The processes and devices in the above description and drawings demonstrate examples of methods and devices of many that could be used and produced to achieve the objects, features, and advantages of embodiments described herein. While the invention has been described in detail and with reference to specific embodiments thereof, it would be apparent to those skilled in the art that various changes, arrangements and modifications may be applied therein without departing from the spirit and scope of the invention. Thus, the embodiments are not to be seen as limited by the foregoing description of the embodiments, but only limited by the appended claims.

What is claimed as new and desired to be protected by Letters Patent of the United States:

1. A mobile wireless communication system, the system comprising:
a server that stores information;
an administration computer connected to the server that controls user access rights;
a teacher computer connected to the server that assigns problem sets to wireless mobile devices; and
a wireless mobile device connected to the server via a wireless internet connection, the wireless mobile device presenting the problem sets to students,
wherein the wireless mobile device enables communications about the problem sets with other wireless mobile devices connected to the same problem sets, and
wherein the teacher computer includes tools for monitoring and editing the communications.

2. The mobile wireless communication system of claim 1, wherein the server stores a repository of questions in a database or other storage unit.

3. The mobile wireless communication system of claim 2, wherein the teacher computer enables selections of questions to be presented on the wireless mobile device from the repository of questions.

4. The mobile wireless communication system of claim 2, wherein the teacher computer enables rating of questions in the repository of questions, the ratings being transmitted to the server and compiled with ratings provided by at least one other teacher computer.

5. The mobile wireless communication system of claim 1, wherein the server stores an e-content database containing digital snippets that provide educational information related to concepts in the problem sets.

6. The mobile wireless communication system of claim 5, wherein the teacher computer displays the digital snippets from the e-content database as they will appear on the mobile device and enables selection of digital snippets to be made accessible on the wireless mobile device.

7. The mobile wireless communication system of claim 1, wherein rewards are granted for completing the problem sets.

8. The mobile wireless communication system of claim 7, wherein the rewards include the enablement of mobile wireless device features.

9. The mobile wireless communication system of claim 7, wherein the rewards include at least one of: minutes to talk over the mobile wireless device's wireless connection, the ability to take pictures, the ability to send text messages, the ability to browse the internet, the ability download videos, the ability to download music, and the ability to download games

10. The mobile wireless communication system of claim 1, wherein the administration computer monitors content uploaded by students.

11. The mobile wireless communication system of claim 1, wherein the server filters content uploaded by students based on predetermined words or phrases.

12. The mobile wireless communication system of claim 1, further comprising a parent computer that provides reports on student progress.

13. The mobile wireless communication system of claim 12, wherein the parent computer sends messages to the teacher computer.

14. The mobile wireless communication system of claim 1, wherein all communications are passed through a content filter on the server.

15. The mobile wireless communication system of claim 1 wherein the communications include message board postings.

16. The mobile wireless communication system of claim 1 wherein the communications include instant messaging.

17. The mobile wireless communication system of claim 1 wherein the communications include blog postings and comments.

18. The mobile wireless communication system of claim 1, wherein the problem sets are correlated with state education standards.

19. The mobile wireless communication system of claim 1, wherein the server stores a user access database.

20. The mobile wireless communication system of claim 1, wherein all inputs on the wireless mobile device are logged on a local storage of the wireless mobile device and uploaded to the server.

21. The mobile wireless communication system of claim 20, wherein at least one of the teacher computer and the administrator computer provides access to reports compiling said inputs.

22. The mobile wireless communication system of claim 21, wherein said reports include information on communications from the wireless mobile device.

23. The mobile wireless communication system of claim 21, wherein said reports include information on progress on problem sets on the wireless mobile device.

24. The mobile wireless communication system of claim 20, wherein the inputs are logged as an XML file.

25. A method of communicating education information through a wireless device comprising:
providing a teacher with the ability to select a problem correlated with a lesson plan;
providing a mobile wireless device that presents the problem to a student;
providing access to supplemental materials relating to the problem, the supplemental materials being accessed on the mobile wireless device;
providing the student with the ability to communicate with other students via the mobile wireless device.

26. The method of claim 25, wherein communications between students are monitored by an administrator.

27. The method of claim 25, wherein communications between students are filtered by a content filter.

28. The method of claim 25, further comprising the step of: providing the teacher with the ability to select the problem from a database of questions correlated to State education standards.

29. The method of claim 25, further comprising the step of: providing the teacher with the ability to select the supplemental materials.

30. The method of claim 25, further comprising the step of: providing the teacher with the ability to rate the supplemental materials.

31. The method of claim 25, further comprising the step of: providing the teacher with the ability to create the supplemental materials.

32. The method of claim 25, further comprising the step of: providing the teacher with the ability to monitor progress of a student using the mobile wireless device.

33. The method of claim 25, further comprising the step of: providing rewards for solving problems.

34. The method of claim 25, further comprising the step of: providing rewards for assisting other users.

35. The method of claim 25, further comprising the step of: providing an administrator computer that monitors communications between the users.

36. The method of claim 25, further comprising the step of: providing a parent computer that delivers a report on student performance.

37. A method of presenting problems to a student on a mobile wireless device, the method comprising:
a) presenting the student with a first problem;
b) presenting the student with materials to assist the student in solving the first problem;
c) presenting the student with at least a second randomly generated problem once the student solves the first problem, the second randomly assigned problem incorporating different parameters.

38. The method of claim 37, wherein the student is not presented with the materials when solving the second randomly assigned problem.

39. The method of claim 37, wherein the student is granted the ability to collaborate with other students when solving the first problem.

40. The method of claim 37, wherein the materials are selected by a teacher.

41. The method of claim 37, wherein the first problem is selected by a teacher.

42. A handheld educational device comprising:
a housing;
memory contained within the housing;
a wireless transmitter that sends and receives a wireless communication signal;
a display device affixed to an external side of the housing; and
an input unit affixed to an external side of the housing,
wherein the device presents educational problems to be solved by a user by entering information via the input unit, and
wherein the memory stores a user's progress and a record of the user's actions.

43. The handheld educational device of claim 42 wherein the wireless transmitter uploads a user's progress and a record of the user's actions to a server.

44. The handheld educational device of claim 42 wherein the device receives problems from a repository stored on an external server.

45. The handheld educational device of claim 42 wherein the device provides rewards based on user progress.

46. The handheld educational device of claim 42 wherein the wireless transmitter enables wireless communication with other users.

47. The handheld educational device of claim 46 wherein communications between users are monitored by an administrator.

48. The handheld educational device of claim 42 wherein the device is wirelessly connected to the Internet.

49. A server for wireless education communications comprising:
a memory storing a user access database that contains access rights for user profiles, a database of educational problem sets, and an e-content database storing educational content related to the problem sets;
a transmission module that communicates with a plurality of wireless mobile devices, said transmission module configured to transmit educational problem sets and associated educational content to the wireless mobile devices; and
at least one processor that filters all communications originating from the wireless mobile devices, said filter removing and logging communications that include predefined objectionable content,
wherein the server provides access to information about the logged communications and progress on the educational problem sets by the wireless mobile devices.

50. The server of claim 49, wherein said at least one processor is configured to generate a report on student progress based on transmissions received from each of said wireless mobile devices, and said transmission module is configured to communicate the report to a teacher computer.

51. The server of claim 49, wherein the server provides real-time monitoring of actions on the wireless mobile device.
